(19) United States
(12) Patent Application Publication
(10) Pub. No.: US 2012/0311786 A1
(43) Pub. Date: Dec. 13, 2012

(54) EQUIPMENT HOLDER

(76) Inventors: Steven A. Dixon, Cincinnati, OH (US); Richard H. Heimbrock, Cincinnati, OH (US); Thomas F. Heil, Batesville, IN (US); Charles A. Howell, Batesville, IN (US); Karen Lanning, Batesville, IN (US); Marcia E. Belcher, Canal Winchester, OH (US); David W. Hornbach, Brookville, IN (US)

(21) Appl. No.: 13/494,009

(22) Filed: Jun. 11, 2012

Related U.S. Application Data
(60) Provisional application No. 61/495,852, filed on Jun. 10, 2011.

(51) Int. Cl. A61G 7/05; A61G 7/015

(52) U.S. Cl. 5/613; 5/600

(57) ABSTRACT

A person-support apparatus comprises a frame a deck, and an equipment support. The deck is movably coupled to the frame and configured to support a person thereon. The equipment support is coupled to the deck and configured to move with the deck. The equipment support is configured to maintain its orientation with respect to the deck as the deck moves with respect to the frame.

This application claims priority to U.S. Provisional Application Ser. No. 61/495852, filed Jun. 10, 2011, the contents of which are hereby incorporated by reference.

### BACKGROUND OF THE DISCLOSURE

This disclosure relates to equipment holders. More particularly, but not exclusively, one illustrative embodiment relates to an equipment holder coupled to the head and torso deck section.

Some hospital equipment, such as, breathing tube circuits and pressure transducers, are maintained in an initial position with respect to the person they are attached to. When the bed is moved, for example, raising and lowering the vertical height of the bed and/or increasing and decreasing the angle of inclination of the person's head and torso, the initial position of the equipment can change with respect to the person. While various equipment holders have been developed, there is still room for improvement. Thus, a need persists for further contributions in this area of technology.

### SUMMARY OF THE DISCLOSURE

One illustrative embodiment may include an equipment support assembly coupled to a head and torso section of a deck and configured to maintain its orientation with respect to the deck as the head and torso section moves between a first position and a second position. In some contemplated embodiments, the equipment support assembly is coupled to the head and torso section of the deck by a bracket with a support coupler. Also, in some contemplated embodiments, the equipment support assembly is coupled to the head and torso section of the deck by a support assembly coupler that maintains its orientation with respect to the deck by way of a 4-bar mechanism.

Additional features, which alone or in combination with any other feature(s), such as those listed above and/or those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

Referring now to the illustrative examples in the drawings, wherein like numerals represent the same or similar elements throughout:

FIG. 1 is a perspective view of a person-support apparatus according to one illustrative embodiment of the current disclosure;

FIG. 2 is a diagrammatic side view of the upper frame of FIG. 1 showing the deck and upper frame base;

FIG. 3 is a diagrammatic side view of the upper frame of FIG. 1 showing the equipment support assembly coupled to the head and torso section of the deck;

FIG. 4 is a diagrammatic side view of the upper frame of FIG. 1 showing the mounting bracket coupled to the head and torso section;

FIG. 5 is a side perspective view of the mounting bracket of FIG. 4 according to one illustrative embodiment;

FIG. 6 is a side perspective view of the mounting bracket of FIG. 4 according to another illustrative embodiment;

FIG. 7 is a diagrammatic side view of the mounting bracket of FIG. 6;

FIG. 8 is a side perspective view of the equipment support assembly of FIG. 3 showing a retaining configuration according to one illustrative embodiment;

FIG. 9 is a side perspective view of the equipment support assembly of FIG. 3 showing a retaining configuration according to another illustrative embodiment;

FIG. 10 is a side perspective view of the equipment support assembly of FIG. 3 showing a retaining configuration according to another illustrative embodiment;

FIG. 11 is a side view of the equipment support assembly of FIG. 3 showing a retaining configuration according to another illustrative embodiment;

FIG. 12 is a side perspective view of the equipment support assembly of FIG. 3 showing an equipment holder according to one illustrative embodiment;

FIG. 13 is a side perspective view of the equipment support assembly of FIG. 3 showing an equipment holder according to another illustrative embodiment;

FIG. 14 is a diagrammatic side view of the upper frame of FIG. 3 showing a support assembly coupler coupled to the head and torso section by way of a 4-bar link mechanism;

FIG. 15 is a diagrammatic side view of the upper frame of FIG. 3 showing a support assembly coupler coupled to the head and torso section by way of a 4-bar link mechanism.

### DESCRIPTION OF SPECIFIC ILLUSTRATIVE EMBODIMENTS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment may include an equipment support assembly coupled to a head and torso section of a deck and configured to maintain its orientation with respect to the deck as the head and torso section moves between a first position and a second position. In some contemplated embodiments, the equipment support assembly is coupled to the head and torso section of the deck by a bracket with a support coupler. Also, in some contemplated embodiments, the equipment support assembly is coupled to the head and torso section of the deck by a support assembly coupler that maintains its orientation with respect to the deck by way of a 4-bar mechanism.

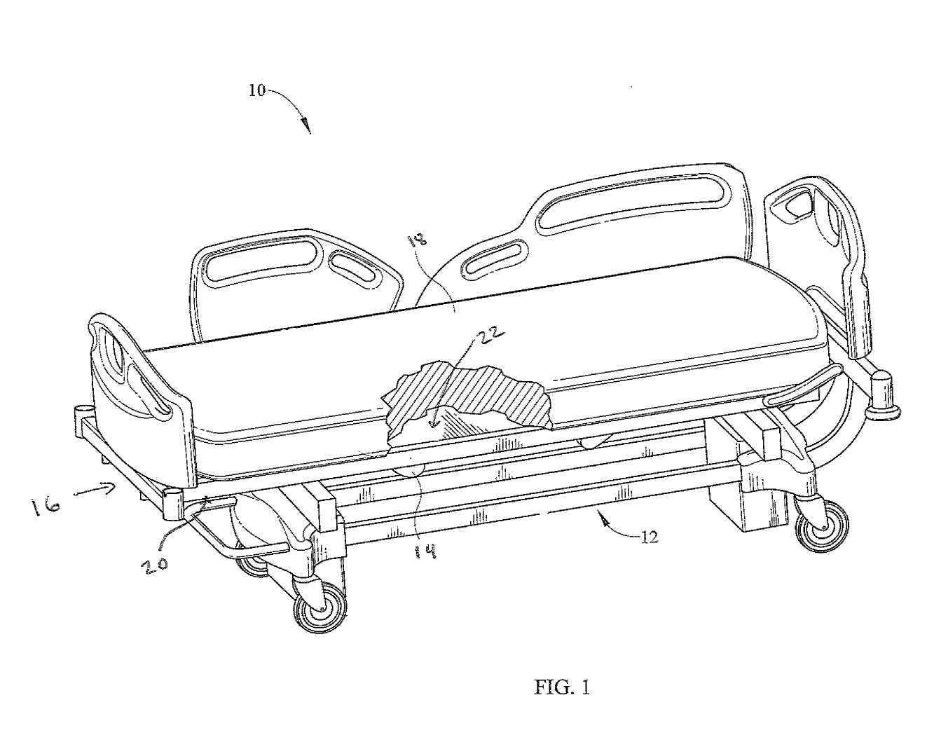

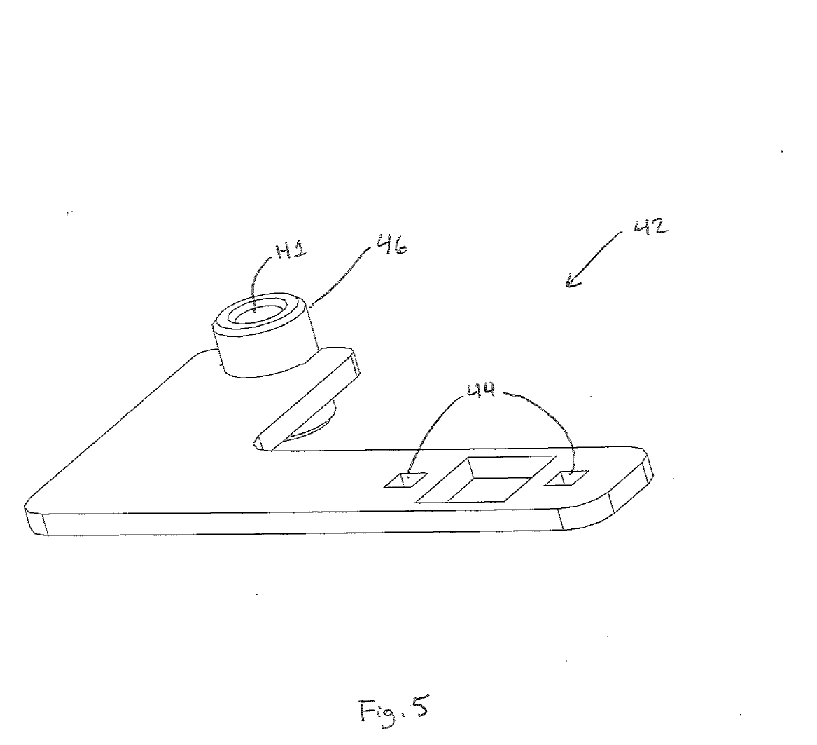

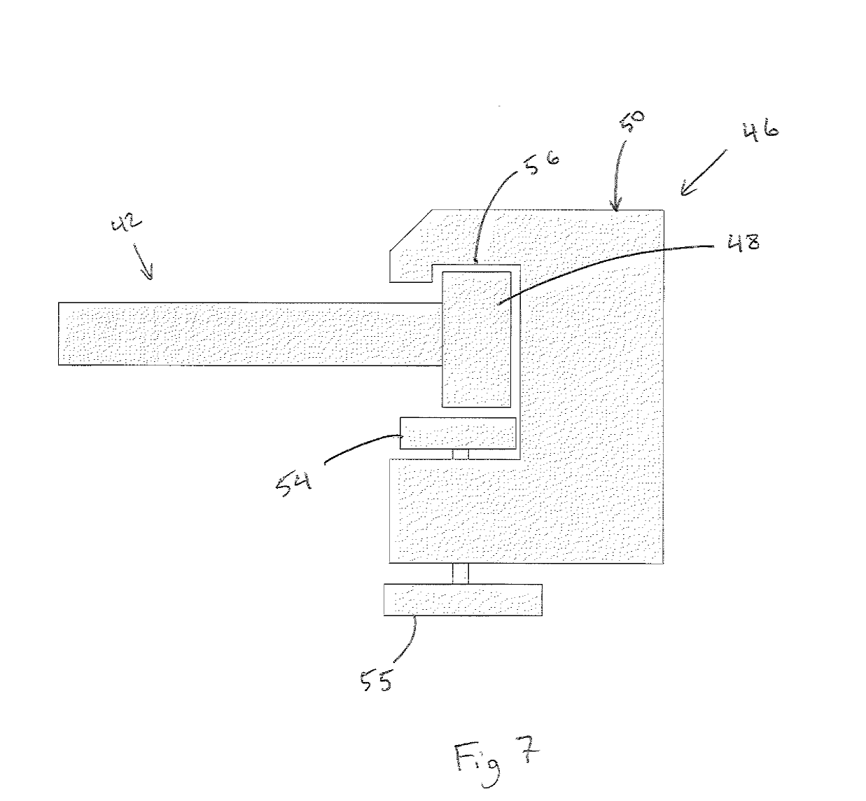

A person support apparatus 10 according to one illustrative embodiment of the current disclosure is shown in FIGS. 1-13. The person-support apparatus 10 includes a lower frame 12 or base frame 12, supports 14 or lift mechanisms 14 coupled to the lower frame 12, and an upper frame 16 movably supported above the lower frame 12 by the supports 14 as shown in FIG. 1. In some embodiments, a mattress 18 is supported on the upper frame 16. The upper frame 16 includes an upper frame base 20, a deck 22 supported on the upper frame base 20, and an equipment support assembly 24.

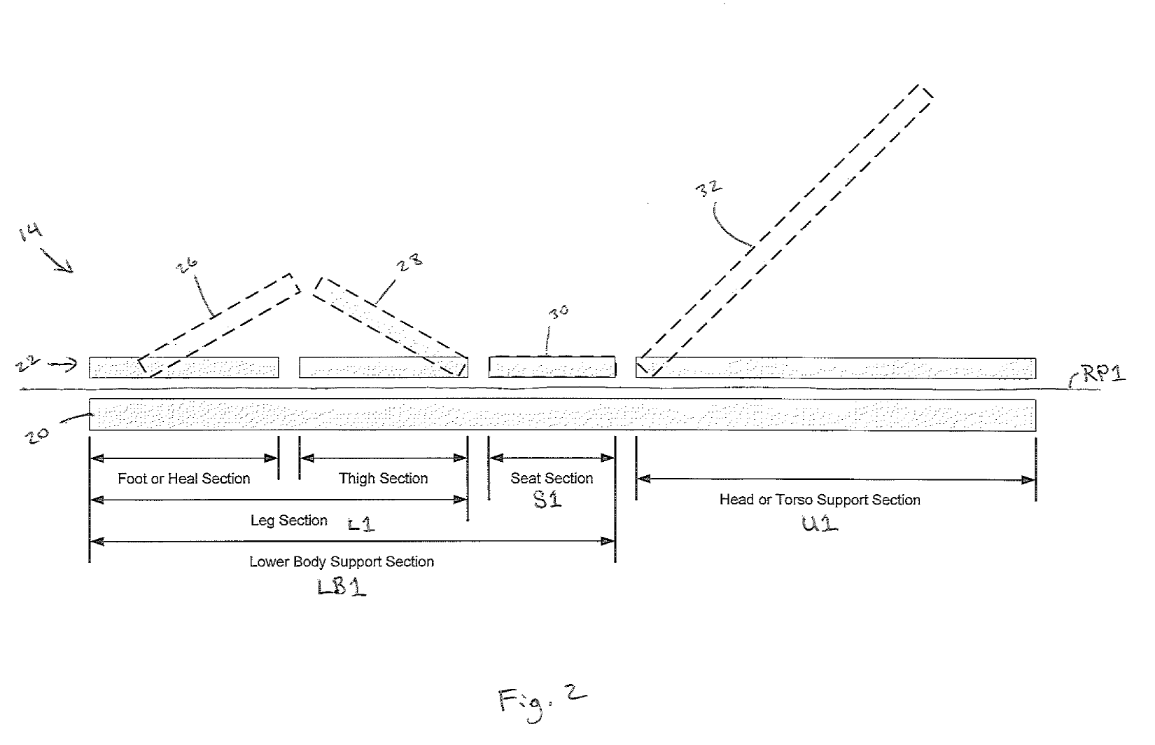

The deck 22 is configured to move the upper frame 18 between various articulated configurations. In some contemplated embodiments, the deck 22 is supported on a deck support frame DS 1 that is configured to move with respect to the upper frame base 20 to move the deck between the various articulated positions. The deck includes a calf section 26, a thigh section 28, a seat section 30, and a head and torso section 32 as shown in FIG. 2. The calf section 26 and the thigh section 28 define a lower limb support section L1. The head and torso section 32 define an upper body support section U1. In some embodiments, the deck 22 is coupled to the upper frame base 20 by a movement mechanism 134 described below. The seat section 30 defines the seat support section S1. The calf section 26, the thigh section 28, and the seat section 30 define a lower body support section LB1. At least the calf section 26, the thigh section 28, and the head and torso section 32 are movable with respect to one another and the upper frame base 20. In some embodiments, the calf section 26, the thigh section 28, the seat section 30, and the head and torso section 32 cooperate together to move the person-support apparatus 10 between a lying down (substantially horizontal) configuration and a recumbent or reclined configuration. Also, in some embodiments, the person-support apparatus is moved between the lying down configuration and a chair configuration. Further, in some contemplated embodiments, the head and torso section 32 is moved such that it is at an angle of at least about 30° with respect to a reference plane RP1 passing through the upper frame 20.

The equipment support assembly 24 is configured to prevent relative motion between the equipment supported by the equipment support assembly 24 and a person supported on the person-support apparatus 10. In some embodiments, the equipment support assembly 24 is configured to prevent relative motion between a person supported on the person-support apparatus 10 and a breathing tube circuit. In some contemplated embodiments, the equipment support assembly 24 includes a Fisso® twin fixing circuit holder (Art. No. 5.434, Code K12), a Fisso® articulated arm (Art. No. 2.60, Code G5), and two Fisso® swinging heads with fine adjustment (Art. No. 5.420, Code Z1) sold by Baitella AG. Also, in some embodiments, the equipment support assembly 24 is configured to prevent relative motion between a person supported on the person-support apparatus 10 and one or more a pressure transducers. In some contemplated embodiments, the equipment support assembly 24 includes a Fisso® clamp for pressure transducer plates (Art. No. 5.406, Code K8), a Fisso® articulated arm (Art. No. 2.60, Code G5), and two Fisso® swinging heads with fine adjustment (Art. No. 5.420, Code Z1) sold by Baitella AG.

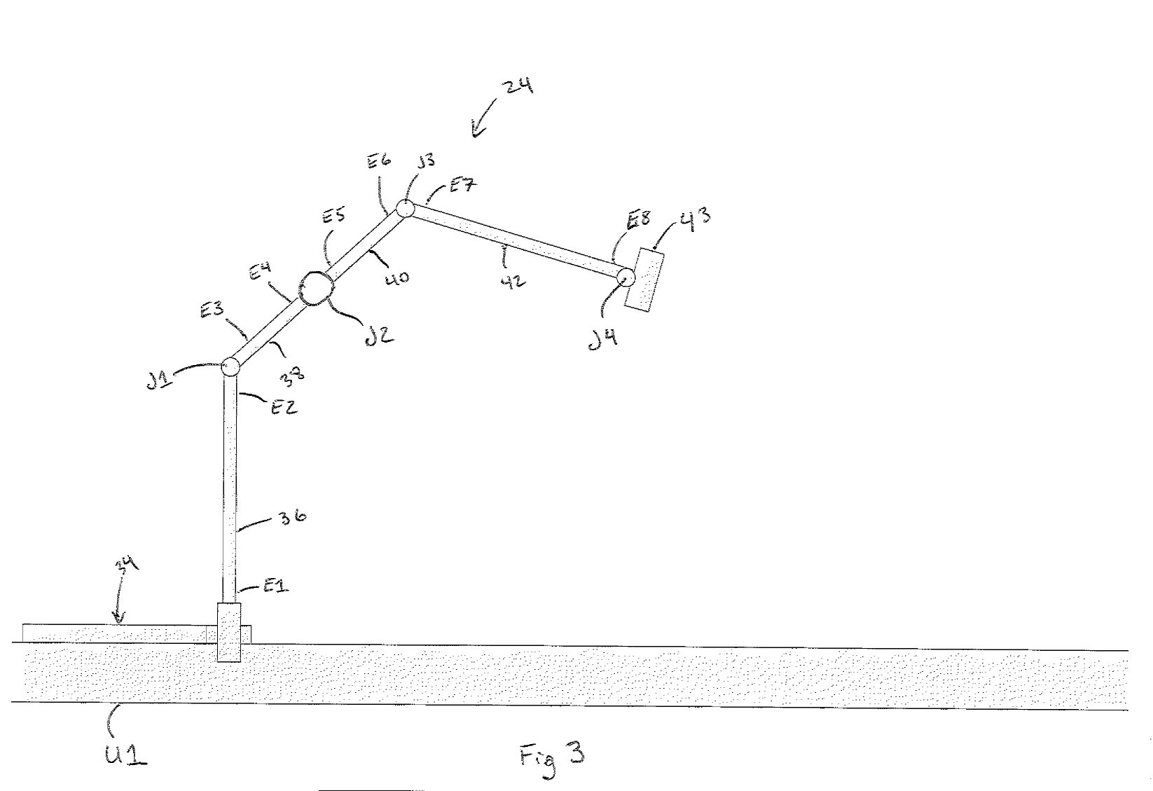

The equipment support assembly 24 includes a mounting bracket 34, a first support link 36, a second support link 38, a third support link 40, a fourth support link 42, and an equipment holder 43 as shown in FIGS. 3-13. In some embodiments, the first support link 36 and the fourth support link 42 are Fisso® swinging heads with fine adjustment (Art. No. 5.420, Code Z1), and the second support link 38 and the third support link 40 are a Fisso® articulated arm (Art. No. 2.60, Code G5).

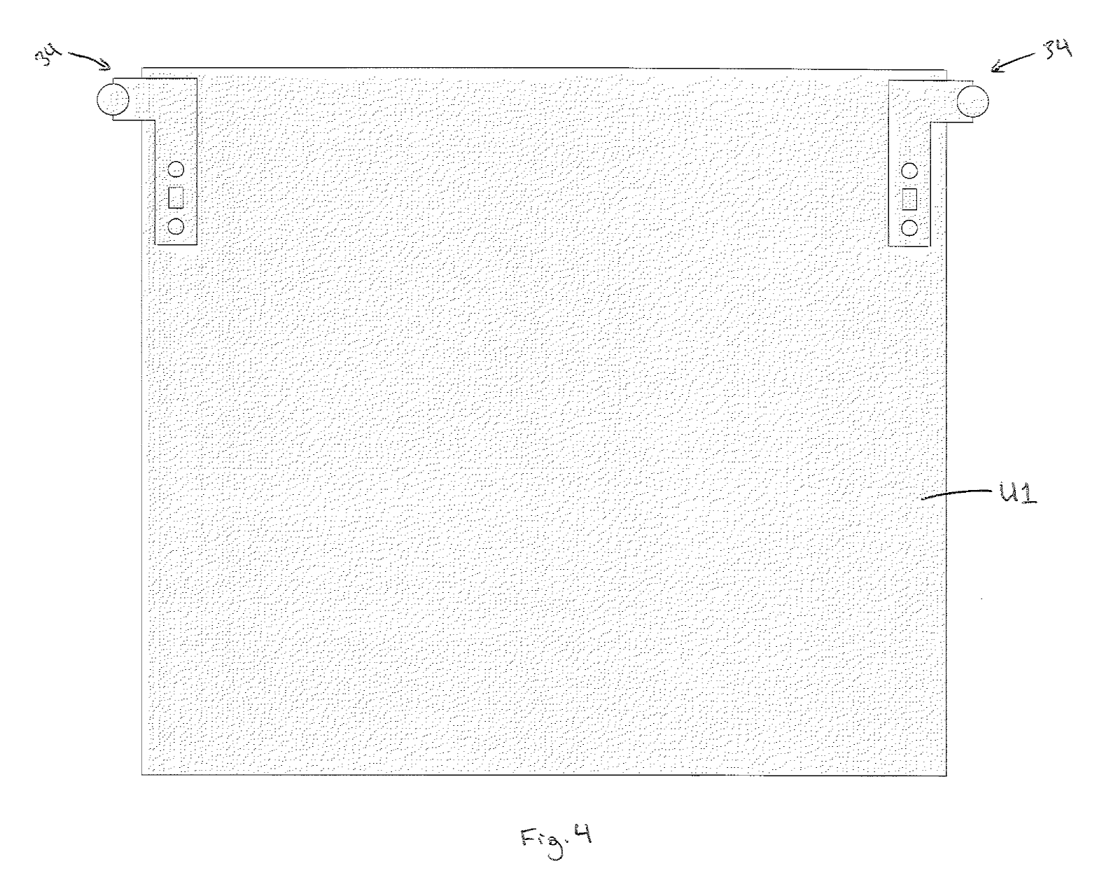

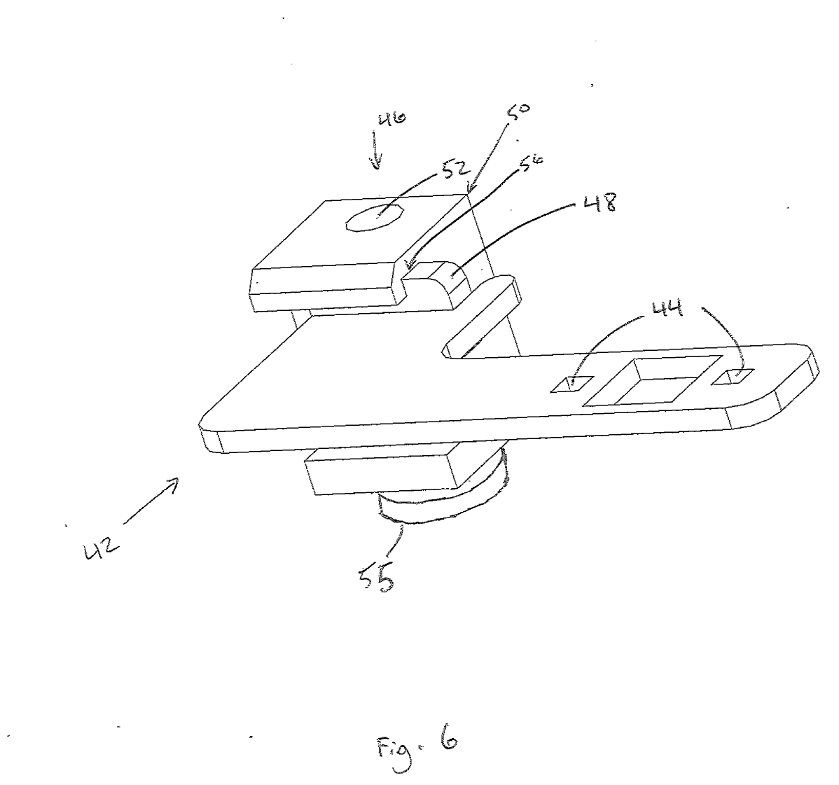

The mounting bracket 42 is substantially L-shaped and includes a pair of holes 44 and a support coupler 46. The holes 44 are configured to be engaged by fasteners (not shown) to secure the mounting bracket 42 to the head and torso section 32 as shown in FIGS. 4 & 5. In some embodiments, the support coupler 46 is welded to the mounting bracket 42 and includes a hole H1 therethrough configured to receive the first support link 36. Also, in some embodiments, the mounting bracket 42 includes a flange 48 welded thereto that is configured to be engaged by the support coupler 46 including a housing 50, a hole 52 configured to receive the first support link 36, a clamping base 54 coupled to an end of a knob with a threaded shaft (threaded knob) 55 threadably engaging the housing 50 and configured to move the clamping base 54 with respect to the housing 50, and a second clamping surface 56 recessed into the housing 50 opposite the clamping base 54 as shown in FIGS. 6 & 7. In some contemplated embodiments, the support coupler 46 includes a Fisso® rail clamping base (Art. No. 5.260, Code S8).

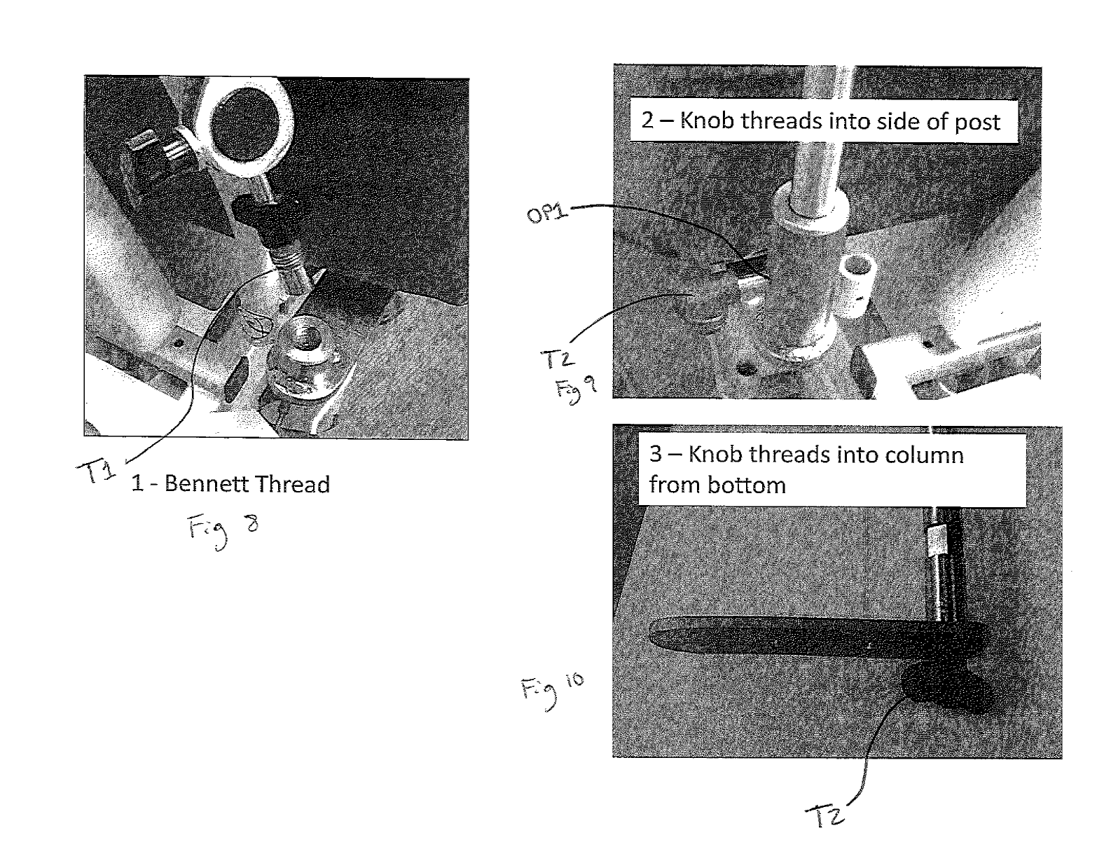

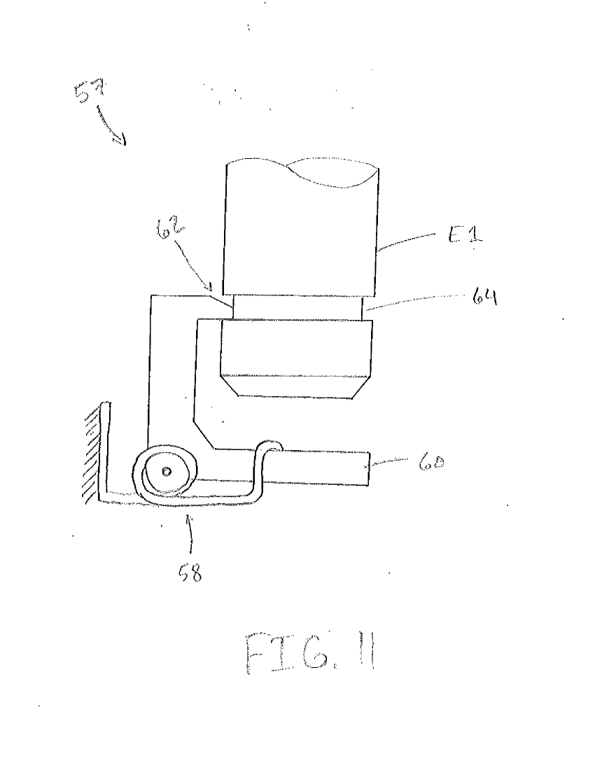

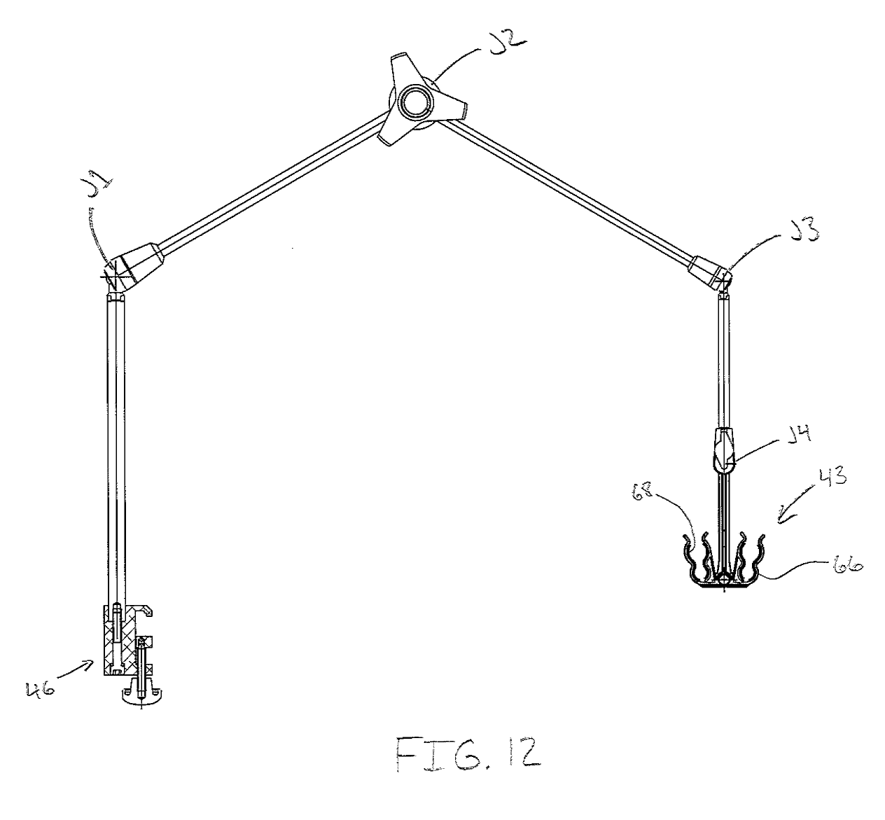

The first support link 36 is coupled between the support coupler 46 and the second support link 38 as shown in FIG. 3. The first end E1 of the first support link 36 is coupled to the support coupler 46 and the second end E2 of the first support link 36 is connected to the first end E3 of the second support link 38 at a first mechanically clamping ball joint J1. In some embodiments, the first end E1 is keyed with flat surfaces and includes Bennett threads T1 that are configured to engage corresponding structure (not shown) in the support coupler 46 as shown in FIG. 8. Also, in some embodiments, a threaded knob T2 is configured to threadably engage an opening OP1 that passes through the side of the support coupler 46 to selectively engage and retain the first end El in the support coupler 46 as shown in FIG. 9. Also, in some embodiments, the knob T2 with the threaded shaft is configured to threadably engage an opening (not shown) in the first end El through an opening (not shown) at the bottom of the support coupler 46 to selectively engage and retain the first end E1 in the support coupler 46 as shown in FIG. 10. Further, in some embodiments, the support coupler 46 includes a quick release mechanism 57 with a spring 58 and a latch 60 pivotably coupled to the upper frame base 20 with an engagement post 62 configured to selectively engage a slot 64 in the first end El as shown in FIG. 11. Also, in some contemplated embodiments, the first end E1 is keyed and engages corresponding structure in the support coupler 46.

The second support link 38 is coupled between the first support link 36 and the third support link 40 as shown in FIG. 3. The first end E3 of the second support link 38 is coupled to the second end E2 of the first support link 36 at the first mechanically clamping ball joint J1 and the second end E4 of the second support link 38 is coupled to the first end E5 of the third support link 40 at a joint J2. In some embodiments, the joint J2 includes a rotational joint with a knob 66 configured to rotate with respect to the second support link 38 to cause the first mechanically clamping ball joint J1 (and a second mechanically clamping ball joint J3 described below) to clamp and un-clamp.

The third support link 40 is coupled between the second support link 38 and the fourth support link 42. The first end E5 of the third support link 40 is coupled to the second end E4 of the second support link 38 at the joint J2 and the second end E6 of the third support link 40 is coupled to the first end E7 of the fourth support link 42 at a second mechanically clamping ball joint J3.

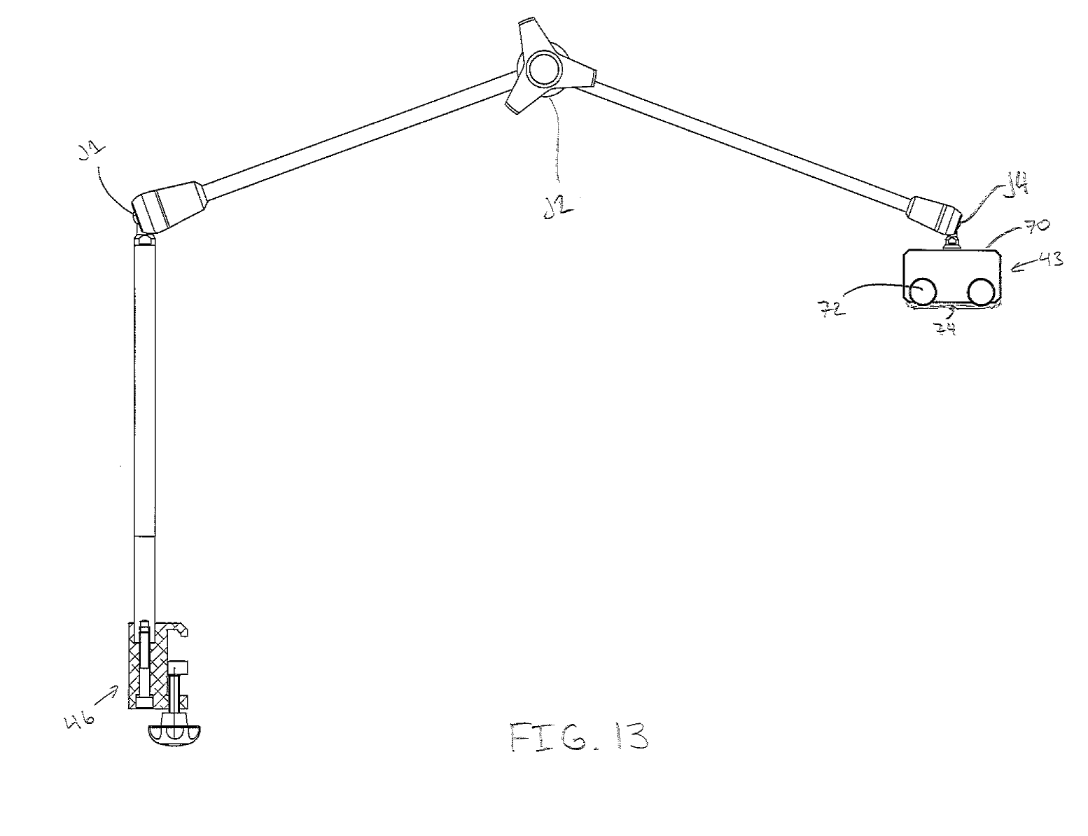

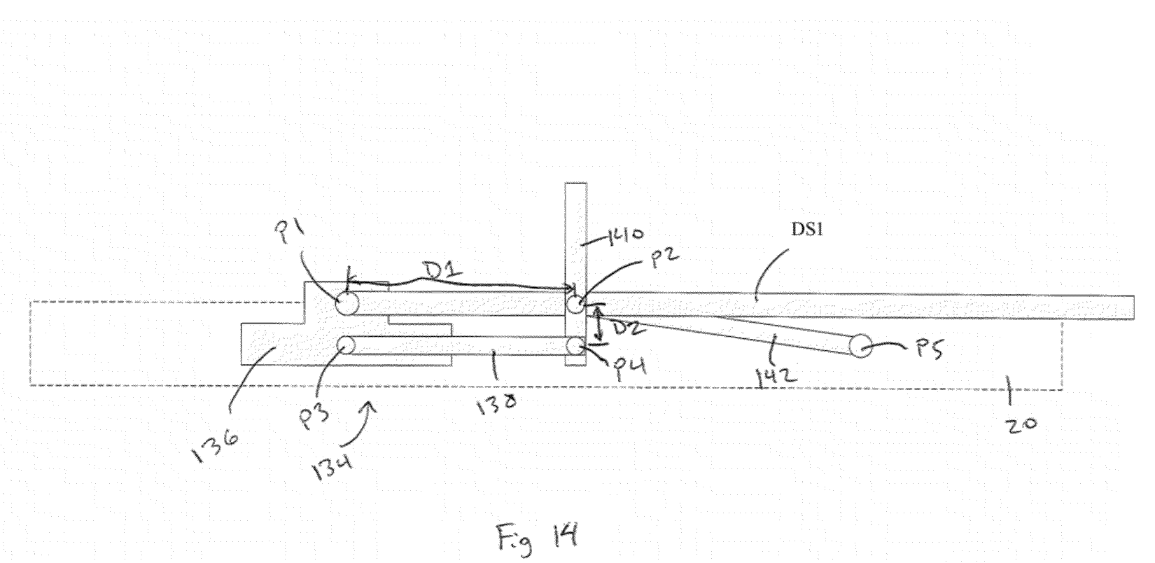

The fourth support link 42 is coupled between the third support link 40 and the equipment holder 43. The first end E7 of the fourth support link 42 is coupled to the second end E6 of the third support link 40 at the second mechanically clamping ball joint J3 and the second end E8 of the fourth support link 42 is coupled to the equipment holder 43 at a fourth ball joint J4. In some embodiments, the equipment holder 43 includes a double hook 66 with a plurality of curved recessed portions 68 configured to hold a tube (not shown) as shown in FIG. 12. In some contemplated embodiments, the equipment holder 43 includes a Fisso® twin fixing circuit holder (Art. No. 5.434, Code K12) as shown in FIG. 12. Also, in some embodiments, the equipment holder 43 includes a mounting plate 70 with a pair of threaded knobs 72 and a slot 74 configured to receive and retain a pressure transducer plate (not shown) as shown in FIG. 13. In some contemplated embodiments, the equipment holder 43 includes a Fisso® clamp for pressure transducer plates (Art. No. 5.406, Code K8) as shown in FIG. 13.

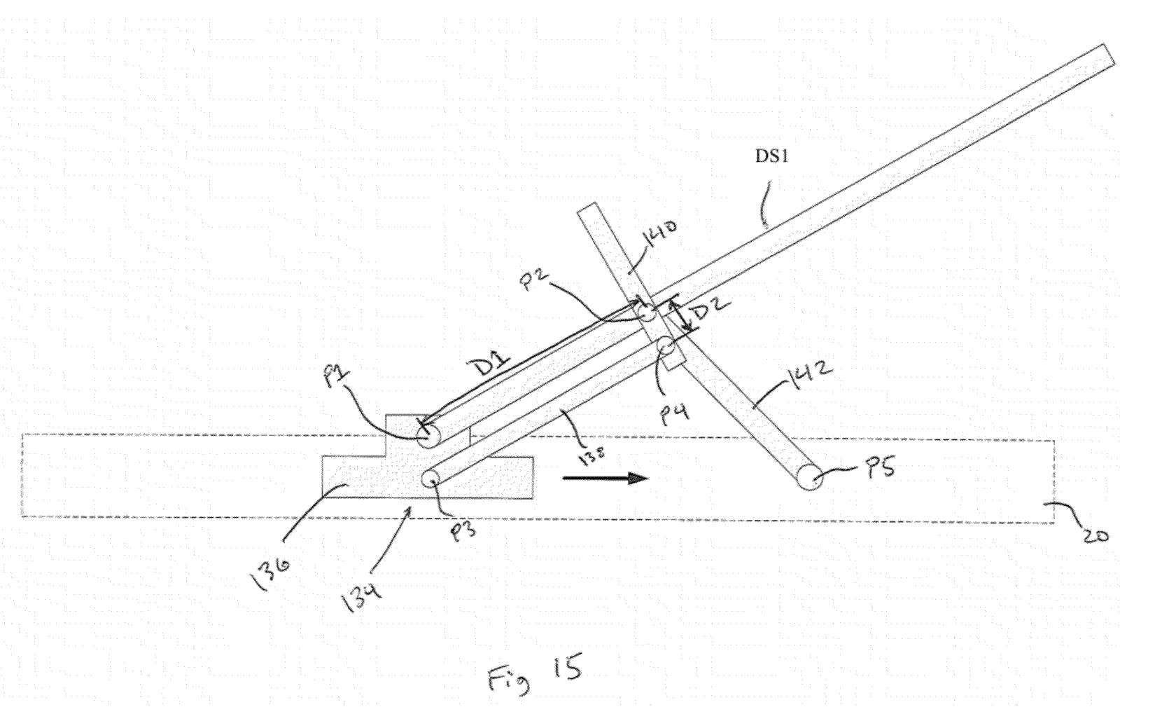

A person support apparatus 10 according to another illustrative embodiment of the current disclosure is shown in FIGS. 14 & 15, wherein like identifiers indicate like features previously described. In this embodiment, the head and torso section 32 of the deck 22 is movably coupled to the upper frame base 20 by a movement mechanism 134. The movement mechanism 134 includes a slide 136, a first link arm 138, a support assembly coupler 140, and a pivot link 142. The slide 136 is supported in a channel (not shown) in the upper frame base 20 and is moved by a movement device, such as, an actuator (not shown), between a first position, where the head and torso section 32 is substantially co-planar with the seat section 30, and a second position, where the head and torso section 32 is at an angle with respect to the seat section 30. The head and torso section 32 is pivotably coupled to the slide 136 at a first pivot P1 and pivotably coupled to the pivot link 142 and the support assembly coupler 140 at a second pivot P2. The first pivot P1 and the second pivot P2 are spaced apart a first distance D1. The first link arm 138 is coupled to the slide 136 at a third pivot P3 and to the support assembly coupler 140 at a fourth pivot P4. The second pivot P2 and the fourth pivot P4 are spaced apart a second distance D2. The first link arm 138, the support assembly coupler 140, the slide 136, and the head and torso section 32 cooperate to define a 4-bar mechanism, which maintains the orientation of the support assembly coupler 140 (and the equipment support assembly 24 coupled thereto) with respect to the head and torso section 32 as the head and torso section 32 moves between the first position and the second position. The pivot link 142 is pivotably coupled to the upper frame base 20 at a fifth pivot P5 and rotates as the slide 136 moves with respect to the upper frame base 20 to pivot the head and torso section 32 between the first position and the second position.

In operation, as the head and torso section 36 is moved from the first position to the second position, the equipment support assembly 24 maintains its orientation with respect to the head and torso section 36. This helps prevent relative motion of the equipment, such as, breathing tube circuits and/or pressure transducers with respect to the person supported on the person-support apparatus.

Many other embodiments of the present disclosure are also envisioned. For example, a person-support apparatus comprises a frame a deck, and an equipment support. The deck is movably coupled to the frame and configured to support a person thereon. The equipment support is coupled to the deck and configured to move with the deck. The equipment support is configured to maintain its orientation with respect to the deck as the deck moves with respect to the frame.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described may be more desirable, it nonetheless may not be necessary and embodiments lacking the same may be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item may include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations may be apparent to those skilled in the art. Also, while multiple inventive aspects and principles may have been presented, they need not be utilized in combination, and various combinations of inventive aspects and principles are possible in light of the various embodiments provided above.

What is claimed is:

1. A person-support apparatus, comprising:
a frame;
a deck movably coupled to the frame and configured to support a person thereon; and
an equipment support coupled to the deck and configured to move with the deck, the equipment support being movable with at least two degrees of rotational freedom with respect to the deck, the equipment support being configured to be selectively locked to maintain its orientation with respect to the deck as the deck moves with respect to the frame.

2. The person-support apparatus of claim 1, wherein the equipment support includes an equipment holder configured to retain a breathing tube circuit.

3. The person-support apparatus of claim 1, wherein the equipment support includes an equipment holder including a double hook with a plurality of curved recessed portions.

4. The person-support apparatus of claim 1, wherein the equipment support includes an equipment holder configured to retain a pressure transducer plate.

5. The person-support apparatus of claim 1, wherein the equipment support includes an equipment holder including a mounting plate, a knob with a threaded shaft, and a slot, the threaded knob and the slot cooperating to retain a pressure transducer plate.

6. The person-support apparatus of claim 1, wherein the equipment support includes at least one ball joint and a lock configured to selectively lock the at least one ball joint.

7. The person-support apparatus of claim 1, wherein the equipment support is removably coupled to a clamp receptacle being configured to be removably secured to a flanged bracket coupled to the deck.

8. A person-support apparatus, comprising:
a frame;
a deck movably coupled to the frame and configured to support a person thereon;
a receptacle coupled to the deck; and
an equipment support removably coupled to the receptacle and configured to move with the deck, the equipment support being configured to maintain its orientation with respect to the deck as the deck moves with respect to the frame.

9. The person-support apparatus of claim 8, wherein the equipment support includes an equipment holder configured to retain a breathing tube circuit.

10. The person-support apparatus of claim 8, wherein the equipment support includes an equipment holder configured to retain a pressure transducer plate.

11. The person-support apparatus of claim 8, wherein the equipment support includes at least one ball joint and a lock configured to selectively lock the at least one ball joint.

12. The person-support apparatus of claim 8, wherein the equipment support is removably coupled to a clamp receptacle being configured to be removably secured to a flanged bracket coupled to the deck.

13. A person-support apparatus, comprising:
a frame;
a deck movably coupled to the frame and configured to support a person thereon;
a receptacle coupled to the frame;
an equipment support coupled to the receptacle; and
a linkage coupled to the frame and the receptacle and configured to maintain the orientation of the equipment support with respect to the deck as the deck moves with respect to the frame.

14. The person-support apparatus of claim 13, wherein the equipment support includes an equipment holder configured to retain a breathing tube circuit.

15. The person-support apparatus of claim 13, wherein the equipment support includes an equipment holder including a double hook with a plurality of curved recessed portions.

16. The person-support apparatus of claim 13, wherein the equipment support includes an equipment holder configured to retain a pressure transducer plate.

17. The person-support apparatus of claim 13, wherein the deck pivots and translates with respect to the frame as the deck changes orientation with respect to the frame.

18. The person-support apparatus of claim 13, wherein the frame includes an upper frame base and a deck support frame, the deck support frame being configured to move the deck with respect to the upper frame base.

19. The person-support apparatus of claim 18, wherein the deck support frame is coupled to a slide configured to translate along the upper frame base, the linkage including a link coupled to the slide and the receptacle and being substantially parallel to the deck support frame.

20. The person-support apparatus of claim 13, wherein the linkage is a four bar mechanism.
